(19) United States
(12) Patent Application Publication
(10) Pub. No.: US 2025/0377818 A1
(43) Pub. Date: Dec. 11, 2025

(54) MIGRATE COMMAND ASSOCIATED WITH TAGGED CAPACITY IN A COMPUTE EXPRESS LINK (CXL) MEMORY DEVICE COUPLED WITH A NONVOLATILE MEMORY EXPRESS (NVME) MEMORY DEVICE

(71) Applicant: MICRON TECHNOLOGY, INC., Boise, ID (US)

(72) Inventor: John M. Groves, Austin, TX (US)

(21) Appl. No.: 19/211,849

(22) Filed: May 19, 2025

Related U.S. Application Data
(60) Provisional application No. 63/657,203, filed on Jun. 7, 2024.

(51) Int. Cl. G06F 3/06

(52) U.S. Cl. CPC G06F 3/0647; G06F 3/0604; G06F 3/0659; G06F 3/0683

(57) ABSTRACT

A system can include a first memory device comprising a plurality of dynamic capacity devices, a second memory device, and a processing device, operatively coupled with the first and second memory devices. The processing device is configured to perform operations including receiving a host command to move first data associated with a first tag to the second memory device, wherein the first tag is associated with a first memory section of the plurality of dynamic capacity devices, and wherein the first memory section is allocated to a first host system to store the first data; responsive to receiving the host command to move, determining a second memory section of the second memory device, wherein the second memory section is associated with a namespace of the second memory device; and storing the first data in the second memory section associated with the namespace.

### RELATED APPLICATIONS

This application claims the benefit of U.S. Provisional Patent Application No. 63/657,203, filed Jun. 7, 2024, the entire contents of which are incorporated by reference herein.

### TECHNICAL FIELD

Embodiments of the disclosure relate generally to memory sub-systems, and more specifically, relate to implementing migrate commands associated with tagged capacity in a compute express link (CXL) memory device coupled with a nonvolatile memory express (NVMe) memory device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIGS. 2A and 2B are block diagrams of example systems for using migrate commands associated with tagged capacity in a compute express link (CXL) memory device coupled with a nonvolatile memory express (NVMe) memory device in accordance with some embodiments of the present disclosure.

FIG. 3A illustrates an example migrate command in accordance with some embodiments of the present disclosure.

FIG. 3B illustrates an example of tag mapping data structure in accordance with some embodiments of the present disclosure.

FIG. 3C illustrates an example of logical to physical (L2P) table in accordance with some embodiments of the present disclosure.

FIG. 4 is a flow diagram of an example method for using migrate commands associated with tagged capacity in a compute express link (CXL) memory device coupled with a nonvolatile memory express (NVMe) memory device in accordance with some embodiments of the present disclosure.

FIG. 5 is a flow diagram of an example method for using migrate commands associated with tagged capacity in a compute express link (CXL) memory device coupled with a nonvolatile memory express (NVMe) memory device in accordance with some embodiments of the present disclosure.

FIG. 6 is a block diagram of an example computer system in which embodiments of the present disclosure may operate.

### DETAILED DESCRIPTION

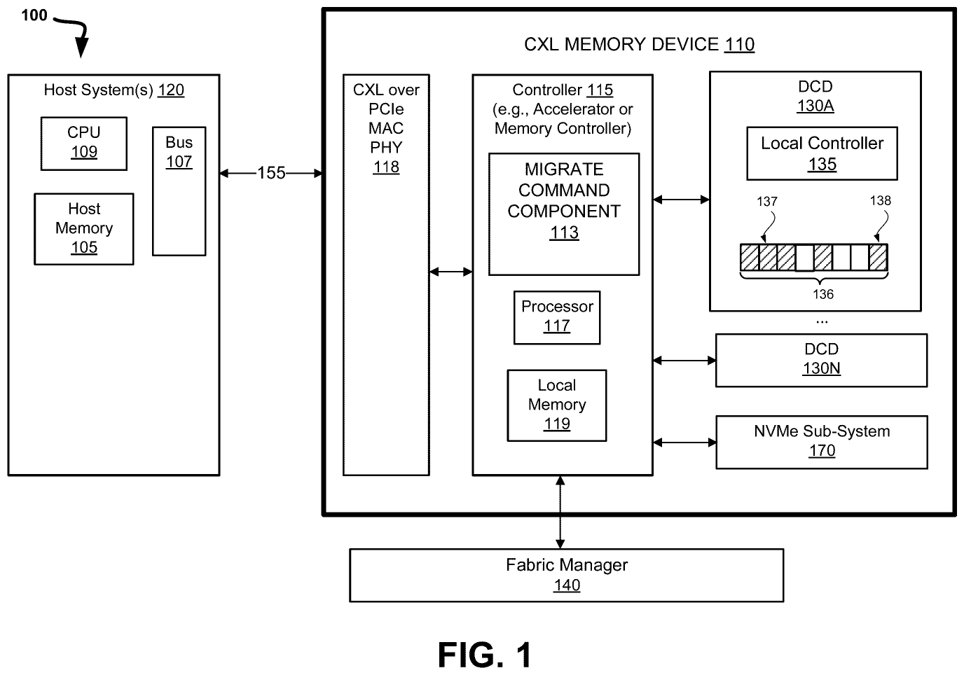

Aspects of the present disclosure are directed to implementing migrate commands associated with tagged capacity in a compute express link (CXL) memory device coupled with a nonvolatile memory express (NVMe) memory device. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A compute express link (CXL) system is an optionally cache-coherent interconnect for processors, memory expansion, and accelerators. A CXL system maintains memory coherency between the CPU memory space and memory on attached devices, which allows resource sharing for higher performance, reduced software stack complexity, and lower overall system cost. Generally, CXL is an interface standard that can support a number of protocols that can run on top of PCIe, including a CXL.io protocol, a CXL.mem protocol and a CXL.cache protocol. The CXL.io protocol is a PCIe-like protocol that can be viewed as an “enhanced” PCIe protocol capable of carving out managed memory. CXL.io can be used for initialization, link-up, device discovery and enumeration, register access, and can provide an interface for I/O devices. The CXL.mem protocol can enable host access to the memory of an attached device using memory semantics (e.g., load and store commands). This approach can support both volatile and persistent memory architectures. The CXL.cache protocol can define host-device interactions to enable efficient caching of host memory with low latency using a request and response approach. Traffic (e.g., NVMe traffic) can run through the CXL.io protocol, and the CXL.mem and CXL.cache protocols can share a common link layer and transaction layer. Accordingly, the CXL protocols can be multiplexed and transported via a PCIe physical layer.

A memory device that supports CXL protocols and can be attached to a host via CXL is referred to as a CXL memory device, which can provide additional bandwidth and capacity to host processors. The CXL memory device is independent of the host memory. In some implementations, the CXL memory device may partition resources into multiple logical devices, and each logical device can be visible as a memory device. In some implementations, the CXL memory device may support multiple host systems. A fabric manager may configure resource allocation for multiple host systems across the logical devices. Dynamic capacity (DC) is a feature of a CXL memory device that allows exposed memory capacity to be allocated and freed dynamically without the need for resetting the CXL memory device. Although the CXL memory device is used here as an illustrative example for implementing the dynamic capacity, the dynamic capacity feature can be applied to other memory devices.

Specifically, a dynamic capacity device (DCD) is a memory device, such as a CXL memory device, that implements dynamic capacity (DC). The device physical address (DPA) range of a DCD can be subdivided into several regions (e.g., 1 to 8 regions) and each of these regions may be further subdivided into a set of blocks. One or more blocks that can be allocated to a host system and associated with a tag are referred to as a taggable DC unit. The taggable DC unit may represent a management unit that can be tagged, assigned in various capacity size, and dynamically allocated to various host systems. A taggable DC unit that has been assigned with a tag is referred to as a tagged capacity unit. Each tag is globally unique, and thus the tags associated with the taggable DC units can form an aggregate tag space in the memory device, such as the CXL memory device, and each tag in the aggregate tag space is uniquely identifiable. Each tag can be associated with one or more host systems and may be mapped to one or more DPA ranges (e.g., a set of one or more contiguous physical address ranges or physical address extent-lists (i.e., non-contiguous address ranges) that identify respective locations storing the data on the DCDs). Each tag may be shareable or not.

Specifically, the fabric manager controls the allocation of these taggable DC units to one or more host systems (or a group of host systems) and utilizes events to signal the host systems when changes to the allocation of these taggable DC units occurs. The fabric manager also assigns a tag to the allocated taggable DC units by associating, in a tag mapping data structure, the tag with the taggable DC units represented by one or more physical addresses (e.g., one or more DPA ranges). The memory device maps the DPA ranges to the taggable DC units. The tag can thus be referred to as representing the tagged capacity units. The host system can map these DPA ranges to corresponding host physical address (HPA) ranges within the host address space available to the host system. In some implementations, the memory device may communicate the state of these tagged capacity units through an extent list that describes the starting DPA and length of all blocks the host system can access, where the extent list is managed by the memory device. The host system (or fabric manager on behalf of the host system) may use a set of commands for querying and configuring the tagged capacity units. The set of commands may include a command allocating the new tagged capacity units (e.g., Initiate Dynamic Capacity Add command), a command releasing the tagged capacity units (e.g., Initiate Dynamic Capacity Release command), and getting information of the tagged capacity units. The capacity of the sharable tagged capacity units associated with a tag and allocated to a host system is immutable such that no additional capacity can be added to the tag, nor can capacity be deleted from the tag. That is, although the content stored in the tagged capacity units can be modified, the mapping between the tag and the tagged capacity units allocated to the host system cannot be modified through the life of the sharable tag. A host system is thus required to request re-allocation for different capacities of tagged capacity units or for different tags being associated. Further, there is a need for moving data associated with tagged capacity to/from other type of memory device, such as the NVMe memory device.

In certain memory devices such as a nonvolatile memory express (NVMe) memory device, the host system can use a logical address space to access the memory device. When the host system requests to access data (e.g., read data, write data), the host system can send a memory access command to the memory device, where the memory access command specifies a logical address from the logical address space. The logical address can identify a logical unit, such as a logical block. For some types of memory devices, a logical block is the smallest write/read unit. For example, the size of data in a logical block can be 512 bytes, 4096 bytes (4 KB), etc., depending on the specification of the memory device. In certain memory devices, a logical block can be a group of logical pages. A logical page is an abstraction of physical pages. A memory sub-system can define a logical page to be equal to a particular unit of physical storage (e.g., a physical page, a physical block, etc.). A logical block address (LBA) is an identifier of a logical block. In an addressing scheme for logical blocks, logical blocks can be identified by their respective integer indices, for example, with the first block being LBA 0, the second being LBA 1, and so on. In certain memory devices, the logical address space of the memory device is divided into namespaces that allow for more efficient management of data. A namespace is a portion of the logical address space, and each namespace can be mapped, through an address mapping data structure, to multiple logical blocks. For example, one or more LBAs can be mapped to a particular namespace. Each namespace can be referenced using a corresponding namespace identifier (namespace ID). For each namespace, the memory sub-system controller can store namespace metadata, for example, a namespace-specific address mapping data structure (e.g., a namespace logical to physical (L2P) table) in a memory device. The namespace-specific address mapping data structure can indicate capabilities and settings that are specific to a particular namespace, and can be created, updated, or deleted, e.g., using NameSpace Management and Namespace Attachment commands as defined by the NVM Express™ (NVMe™) Specification.

Aspects of the present disclosure address the above and other deficiencies by implementing migrate commands associated with tagged capacity in a compute express link (CXL) memory device coupled with a nonvolatile memory express (NVMe) memory device. A migrate command associated with tagged capacity may enable a host system to migrate data stored in a tagged capacity unit associated with a source tag (“data of source tag”) in the CXL memory device to a physical storage unit associated with a namespace in a NVMe memory device (“NVMe namespace”), as well as migrate the data back from the NVMe memory device to the CXL memory device. The size of the physical storage unit associated with a namespace may correspond to the size of the tagged capacity unit associated with the source tag, and each namespace may be unique and one-to-one mapped to a tag. In some implementations, the tag may be identified by a value same as the namespace ID. For easy description, the migrate command that migrate data from the CXL memory device to the NVMe memory device is referred to as a migrate-out command, and the migrate command that migrate data from the NVMe memory device to the CXL memory device is referred to as a migrate-in command.

A migrate-out command associated with tagged capacity enables a host system to move the data of source tag to a physical storage unit associated with a namespace in a NVMe memory device. The migrate-out command may further enable the host system to free the associated tagged capacity unit so that the memory space can be reallocated to fulfill a request for memory resources. To free the tagged capacity unit, the CXL memory device may disassociate, in a tag/namespace mapping data structure, the DPA range with the source tag and mark the DPA range as free to use, and notify the host system as if the source tag has been deleted.

As such, data of source tag is migrated to a NVMe namespace. Although the source tag cannot be changed in the capacity as well as the mapping between the source tag and the tagged capacity units allocated to the host system cannot be modified, the source tag can be released such that the associated tagged capacity units can be re-allocated to other host systems and/or associated with other tags. In some implementations, the host system can select tags for migrating based on certain heuristics, e.g., based on the access frequency, most recent access time, etc.

The migrate-out command may specify the source tag and specify a destination NVMe memory device including the physical storage unit associated with a namespace. The migrate-out command may further specify NVMe access control information. The migrate-out command may enable the host system to update the namespace and its physical addresses (e.g., physical block address (PBA) ranges), in an item, associated with the source tag, of a tag/namespace mapping data structure. The migrate-out command may also hide the DPA ranges from the host system, and therefore, the host system that was previously able to access the data of source tag can no longer access the data in the DCDs but instead need to retrieve the data in the NVMe memory device. In response to an attempt to access the source tag, the host system may receive a notification about the migrated data and/or a recommendation for retrieve (i.e., migrate in) the data.

A migrate-in command associated with tagged capacity enables a host system to move data, associated with the source tag, stored in a physical storage unit of a NVMe namespace to another tagged capacity unit associated with a destination tag (e.g., a new tag or the original source tag).

The migrate-in command may specify the source tag (associated with a namespace ID) for retrieving data. The migrate-in command may specify the host system that can access (e.g., read, write, etc.) the data of the destination tag. The migrate-in command may further specify a selection policy indicating the policy for selecting the taggable DC unit used for the destination tag. The selection policy can include a “free and contiguous” policy that allows a memory controller to select an available and contiguous taggable DC unit, or a “prescriptive” policy that allows the fabric manager to select the taggable DC unit so that the selection is globally controlled. Therefore, the host system that was previously able to access the data of source tag that has been migrated to a NVMe namespace can access the data again by accessing a particular copy (e.g., by referencing a destination tag) of the original data.

Advantages of the present disclosure include efficient modification of tagged capacity units allocated to a host system by using commands regarding the tags. Specifically, the system significantly improves flexibility in using the tagged capacity. Further, aspects of the present disclosure allow compatibility between the tags used in the CXL memory devices and the namespaces used in the NVMe memory devices. The tag can be considered as an identifier of physical location of the CXL memory device and the namespace can be considered as an identifier of logical address of the NVMe memory device; as such, the tag can be linked to namespace for operations that involves the namespace. The NVMe namespace are used as an example for implementing the present disclosure, aspects of the present disclosure can also implement migrate commands associated with tagged capacity in a CXL memory device coupled with other type of memory device(s), as well as other type of data/memory management format such as files instead of namespaces. In one example, the migrate commands allow to migrate data stored in a tagged capacity unit associated with a source tag in the CXL memory device to a physical storage unit associated with a file in a file server (e.g., through a network other than PCIe), as well as migrate the data back from the file server to the CXL memory device.

FIG. 1 illustrates an example computing system 100 that includes a compute express link (CXL) memory device 110 in accordance with some embodiments of the present disclosure. The CXL memory device 110 can include media, such as one or more volatile memory devices, one or more non-volatile memory devices, or a combination of such.

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include one or more host system(s) 120 that are coupled to the CXL memory device 110. In some embodiments, the host system 120 is coupled to multiple CXL memory device 110 of different types. FIG. 1 illustrates one example of a host system 120 coupled to one CXL memory device 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the CXL memory device 110, for example, to write data to the CXL memory device 110 and read data from the CXL memory device 110.

The host system 120 can be coupled to the CXL memory device 110 via a peripheral component interconnect express (PCIe) interface. The PCIe interface is a physical host interface used to transmit data between the host system 120 and the CXL memory device 110 for passing control, address, data, and other signals between the CXL memory device 110 and the host system 120. The host system 120 can further utilize a CXL interface to access components of the CXL memory device 110 when the CXL memory device 110 is coupled with the host system 120 by the physical host interface (e.g., PCIe bus). The host system 120 can further utilize an NVM Express (NVMe) interface to access components (e.g., NVMe sub-system 170) when the CXL memory device 110 is coupled with the host system 120 by the physical host interface (e.g., PCIe bus). FIG. 1 illustrates a CXL memory device 110 including a NVMe sub-system as an example. In general, the host system 120 can access multiple CXL memory devices 110 via a same communication connection, multiple separate communication connections, and/or a combination of communication connections. In some implementations, the host system 120 can be connected to the CXL memory device 110 via a network.

In some embodiments, the host system 120 includes a central processing unit (CPU) 109 connected to a host memory 105, such as DRAM or other main memories. The host system 120 includes a bus 107, such as a memory device interface, which interacts with a host interface 118, via a CXL connection 155.

The CXL connection 155 can include a set of data-transmission lanes (“lanes”) for implementing CXL protocols, including CXL.io protocol, CXL.mem protocol, and CXL.cache protocol. The CXL connection 155 can include any suitable number of lanes in accordance with the embodiments described herein. For example, the CXL connection 155 can include 16 lanes (i.e., CXL ×16).

The host interface 118 may include media access control (MAC) and physical layer (PHY) components, of CXL memory device 110 for ingress of communications from host system 120 to CXL memory device 110 and egress of communications from CXL memory device 110 to host system 120. Bus 107 and host interface 118 operate under a communication protocol, such as a CXL over PCIe serial communication protocol or other suitable communication protocols. Other suitable communication protocols include Ethernet, serial attached SCSI (SAS), serial AT attachment (SATA), any protocol related to remote direct memory access (RDMA) such as Infiniband, iWARP, or RDMA over Converged Ethernet (RoCE), and other suitable serial communication protocols.

The computing system 100 may be a cache-coherent interconnect for processors, memory expansion, and accelerators. The computing system 100 maintains memory coherency between the CPU memory space and memory on attached devices, which allows resource sharing for higher performance, reduced software stack complexity, and lower overall system cost. Generally, CXL is an interface standard that can support a number of protocols that can run on top of PCIe, including a CXL.io protocol, a CXL.mem protocol and a CXL.cache protocol. The CXL.io protocol is a PCIe-like protocol that can viewed as an “enhanced” PCIe protocol capable of carving out managed memory. CXL.io can be used for initialization, link-up, device discovery and enumeration, register access, and can provide an interface for I/O devices. The CXL.mem protocol can enable host access to the memory of an attached device using memory semantics (e.g., load and store commands). This approach can support both volatile and persistent memory architectures. The CXL.cache protocol can define host-device interactions to enable efficient caching of host memory with low latency using a request and response approach. Traffic (e.g., NVMe traffic) can run through the CXL.io protocol, and the CXL.mem and CXL.cache protocols can share a common link layer and transaction layer. Accordingly, the CXL protocols can be multiplexed and transported via a PCIe physical layer.

The CXL memory device 110 is a memory device that allows the host system 120 to use it for memory bandwidth expansion, memory capacity expansion, and persistent memory applications, and as small-scale resource pooling, and large-scale resource pooling and sharing.

In some implementations, the CXL memory device may be a multiple logical device (MLD), which may partition resources into multiple logical devices, and each logical device can be visible as a memory device. One of multiple logical devices can be reserved for a fabric manager to configure resource allocation across the logical devices, while the other logical devices can be available for assigning to the host. In some implementations, the CXL memory device may be a device that supports multiple host systems and may be referred to as fabric-attached memory (FAM). In the context of these computing environments, the term “fabric” can refer to interconnected communication paths that route signals on major components of a chip or between chips of a computing system. This “fabric” can form the architecture of interconnections between processing or compute nodes within a computing device or between multiple computing devices. In this context, processing nodes and compute nodes refer to processing devices operating as nodes on an interconnected network. Fabric-attached memory can refer to a memory architecture in which the memory is connected to the CPU through a fabric interconnect, rather than being directly connected to the CPU. This allows for the memory to be located at a distance from the CPU and can provide benefits such as improved scalability and fault tolerance. For example, in some systems, the fabric includes a bus or a set of connections that connect the processing device of the system to peripheral devices and other processing devices. In other systems, the fabric can also include a set of network connections between combinations of respective compute nodes and memory nodes. In various systems, the fabric acts as an interconnect to create a network of interconnected devices that work together as a single entity. This unified framework incorporates many interconnected devices via the fabric (i.e., like many threads woven together to create a cohesive whole) to provide fast and reliable communication between the devices. In this context, an “interconnect” can refer to a device or system that connects multiple devices or subsystems together to allow them to communicate and exchange data.

The CXL memory device 110 can include a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The CXL memory device 110 can include any combination of the different types of non-volatile memory devices and/or volatile memory devices. The volatile memory devices can be, but are not limited to, random access memory (RAM), such as dynamic random access memory (DRAM) and synchronous dynamic random access memory (SDRAM). Some examples of non-volatile memory devices include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

The DCD 130A-130N can include volatile memory devices including, random access memory (RAM), such as dynamic random access memory (DRAM) and synchronous dynamic random access memory (SDRAM), and non-volatile memory devices including a not-and (NAND) type flash memory and write-in-place memory, such as a 3D cross-point memory device, which is a cross-point array of non-volatile memory cells, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A CXL memory device controller 115 can communicate with the DCD 130A-130N to perform operations such as reading data, writing data, or erasing data at the DCD 130A-130N and other such operations. The CXL memory device controller 115 can include hardware such as one or more integrated circuits and/or discrete components, a buffer memory, or a combination thereof. The hardware can include a digital circuitry with dedicated (i.e., hard-coded) logic to perform the operations described herein. The CXL memory device controller 115 can be a microcontroller, special purpose logic circuitry (e.g., a field programmable gate array (FPGA), an application specific integrated circuit (ASIC), etc.), or other suitable processors.

The CXL memory device controller 115 can include a processing device, which includes one or more processors (e.g., processor 117), configured to execute instructions stored in a local memory 119. In the illustrated example, the local memory 119 of the CXL memory device controller 115 includes an embedded memory configured to store instructions for performing various processes, operations, logic flows, and routines that control operation of the CXL memory device 110, including handling communications between the CXL memory device 110 and the host system 120. The CXL memory device controller 115 may manage operations of CXL memory device 110, such as writes to and reads from DCD 130A-130N. The CXL memory device controller 115 may include one or more processors 117, which may be multi-core processors. Processors 117 can handle or interact with the components of DCD 130A-130N, generally through firmware code. The CXL memory device controller 115 may operate under CXL protocol, but other protocols are applicable.

The CXL memory device controller 115 executes computer-readable program code (e.g., software or firmware) executable instructions (herein referred to as “instructions”). The instructions may be executed by various components of CXL memory device controller 115, such as processor 117, logic gates, switches, application specific integrated circuits (ASICs), programmable logic controllers, embedded microcontrollers, and other components of CXL memory device controller 115. The instructions executable by the CXL memory device controller 115 for carrying out the embodiments described herein are stored in a non-transitory computer-readable storage medium. In certain embodiments, the instructions are stored in a non-transitory computer readable storage medium of CXL memory device 110, such as DCD 130A-130N. Instructions stored in the CXL memory device 110 may be executed without added input or directions from the host system 120. In other embodiments, the instructions are transmitted from the host system 120. The CXL memory device controller 115 is configured with hardware and instructions to perform the various functions described herein and shown in the figures.

The CXL memory device controller 115 may interact with DCD 130A-130N for read and write operations. The CXL memory device controller 115 may execute the direct memory access (DMA) for data transfers between host system 120 and DCD 130A-130N without involvement from CPU 109. The CXL memory device controller 115 may control the data transfer while activating the control path for fetching commands, posting completion and interrupts, and activating the DMA for the actual data transfer between host system 120 and DCD 130A-130N. The CXL memory device controller 115 can have an error correction module to correct the data fetched from the memory arrays in the DCD 130A-130N.

In some embodiments, the local memory 119 can include memory registers storing memory pointers, fetched data, etc. The local memory 119 can also include read-only memory (ROM) for storing micro-code. While the example CXL memory device 110 in FIG. 1 has been illustrated as including the CXL memory device controller 115, in another embodiment of the present disclosure, a CXL memory device 110 does not include a CXL memory device controller 115, and can instead rely upon external control (e.g., provided by an external host, or by a processor or controller separate from the memory sub-system).

In general, the CXL memory device controller 115 can receive commands or operations from the host system 120 or the fabric manager 140 and can convert the commands or operations into instructions or appropriate commands to achieve the desired access to the DCD 130A-130N. The CXL memory device controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical MU address, physical block address) that are associated with the DCD 130A-130N. The CXL memory device controller 115 can further include host interface circuitry to communicate with the host system 120 via the physical host interface. The host interface circuitry can convert the commands received from the host system into command instructions to access the DCD 130A-130N as well as convert responses associated with the DCD 130A-130N into information for the host system 120.

The CXL memory device 110 can also include additional circuitry or components that are not illustrated. In some embodiments, the CXL memory device 110 can include a cache or buffer (e.g., DRAM) and address circuitry (e.g., a row decoder and a column decoder) that can receive an address from the CXL memory device controller 115 and decode the address to access the DCD 130A-130N.

In some embodiments, each or some of DCDs 130A-130N include local media controllers 135 that operate in conjunction with CXL memory device controller 115 to execute operations on one or more memory cells of the DCDs 130A-130N. An external controller (e.g., CXL memory device controller 115) can externally manage the DCDs 130A-130N (e.g., perform media management operations on the memory device 130). In some embodiments, CXL memory device 110 is a managed memory device, which is a raw DCDs 130A-130N having control logic (e.g., local media controller 135) on the die and a controller (e.g., CXL memory device controller 115) for media management within the same memory device package. An example of a managed memory device is a managed NAND (MNAND) device.

In some embodiments, the computing system 100 can include a NVMe sub-system 170. The NVM subsystem 170 may include a non-volatile memory device (e.g., SSD) and a volatile memory device (e.g., DRAM). The non-volatile memory device of the NVM subsystem 170 is used to store host data and may include one or more namespaces. A namespace is a formatted quantity of non-volatile memory device that can be directly accessed by a host system 120. A namespace may be attached to two or more controllers in an NVM subsystem concurrently as a shared namespace among two or more host systems. Each namespace may be associated with metadata including a namespace-specific address mapping data structure (referred to as “L2P table”), where the volatile memory device of the NVM subsystem 170 may be used to store metadata. Each L2P table can be associated with a namespace ID, which is an identifier used by a controller to provide access to a namespace.

In some embodiments, the computing system 100 can include a fabric manager 140. The fabric manager 140 is an external logical process that queries and configures the operational state of the computing system 100, and may include application logic and policy that makes the assignments of DCDs 130A-130N to the host system 120 at run time. In some embodiments, the fabric manager 140 may be software running on the host system 120, firmware embedded within a Baseboard Management Controller (BMC) on another CXL device or a CXL switch, or a dedicated device running in the CXL device. The fabric manager 140 may assign a (logical) device (e.g., DCDs 130A-130N) to the host system 120 by using command sets through the Component Command Interface (CCI). CCI may be exposed through mailbox registers, which provide the ability to issue a command (“mailbox command”) to the device (e.g., DCDs 130A-130N). In some implementations, each of the DCD 130A-130N can include one or more taggable DC units 136. In the example of FIG. 1, the fabric manager 140 may assign one taggable DC unit to the host system 120 and create a globally unique tag attached to the taggable DC unit as a tagged capacity unit 137; the fabric manager 140 may assign another taggable DC unit to the host system 120 and create a globally unique tag attached to the taggable DC unit as a tagged capacity unit 138. Although specific number of taggable dynamic capacity units is shown in FIG. 1 and taggable dynamic capacity units shown in FIG. 1 have the same size of capacity, various sizes of capacities can be allocated to the taggable dynamic capacity units according to the request of the host systems, and the number of taggable dynamic capacity units included in a DCD can vary. In some implementations, the capacity size of a taggable dynamic capacity unit may be a multiple of a minimum capacity size, and the minimum capacity size may be 2 MB, 0.5 GB, 1 GB, etc. In some implementations, some or all of the functionality of the fabric manager 140 may be performed by the controller 115 and/or a migrate command component 113.

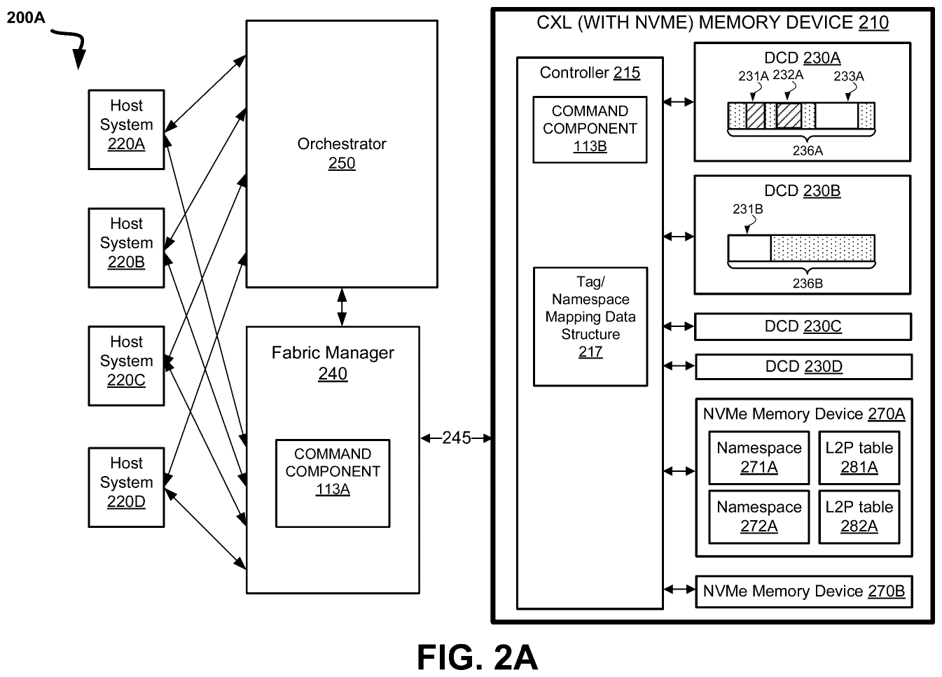

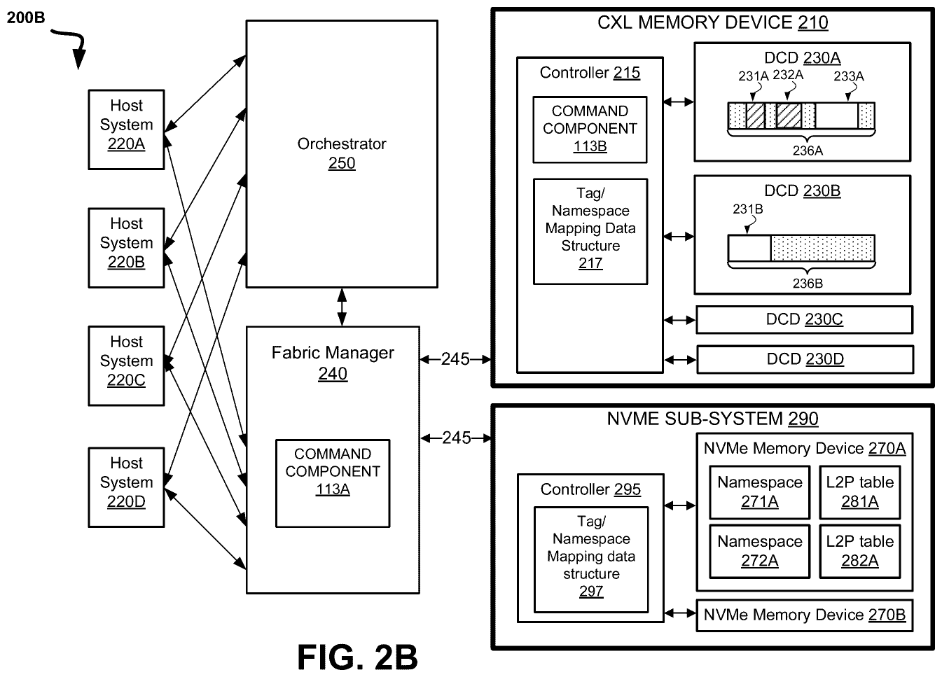

In some embodiments, the CXL memory device 110 includes a migrate command component 113 that enables the host system 120 to perform the migrate command. In some embodiments, the migrate command is a mailbox command described above. In some embodiments, the CXL memory device controller 115 includes at least a portion of the migrate command component 113. In some embodiments, the migrate command component 113 is part of the host system 120, an application, or an operating system. In other embodiments, local media controller 135 includes at least a portion of migrate command component 113 and is configured to perform the functionality described herein. Further details regarding the operations of the migrate command component 113 are described below with reference to FIGS. 2-6. In some implementations, migrate command component 113 includes a command component 113A and a command component 113B as shown in FIG. 2, which may operate together to perform the functionality of the migrate command component 113. In some implementations, some or all of the functionalities of the migrate command component 113 may be performed by the fabric manager 240, the controller 215, the command component 113A, the command component 113B, and/or the combination thereof, as shown in FIG. 2.

It will be appreciated by those skilled in the art that additional circuitry and signals can be provided, and that the components of FIG. 1 have been simplified. It should be recognized that the functionality of the various block components described with reference to FIG. 1 may not necessarily be segregated to distinct components or component portions of an integrated circuit device. For example, a single component or component portion of an integrated circuit device could be adapted to perform the functionality of more than one block component of FIG. 1. Alternatively, one or more components or component portions of an integrated circuit device could be combined to perform the functionality of a single block component of FIG. 1.

FIG. 2A is a schematic block diagram of a system 200 implementing taggable dynamic capacity units in a compute express link (CXL) memory device. In various embodiments, the system 200 includes one or more host systems 220A-D (such as the host system 120), a CXL memory device 210 (such as the CXL memory device 110) that includes a controller 215 (such as controller 115), a CXL fabric interconnect 245, a fabric manager 240 that can perform operations managing the CXL fabric interconnect 245, and an orchestrator 250. In some embodiments, aspects of the controller 215 are included in the processing logic of DCDs 230A-230D. The CXL memory device 210 can be connected to the host systems 220A-D via a network connection interface utilizing the high-speed bus (e.g., a Peripheral Component Interconnect Express (PCIe) bus), such as a compute express link (CXL) fabric interconnect 245. The compute express link (CXL) fabric interconnect 245 may provide an interface that can support several protocols that can run on top of PCIe, including a CXL.io protocol, a CXL.mem protocol, and a CXL.cache protocol. The CXL fabric interconnect 245 may be a collection of one or more switches, and each switch is port based routing (PBR) capable and interconnected with PBR links. The CXL fabric interconnect 245 can connect one or more host ports to the devices within a single coherent host physical address (HPA) space.

In the example of FIG. 2A, the DCD 230A may include a first region 236A, and the DCD 230B may include a second region 236B. As shown in FIG. 2A, each region of the first region 236A and second region 236B may include one or more taggable dynamic capacity units. The CXL memory device 210 may further include NVMe memory devices 270A-270B. The NVMe memory devices 270A, 270B may include one or more non-volatile memory devices (e.g., SSD) for storing one or more namespaces and one or more volatile memory devices (e.g., DRAM) for storing the L2P tables.

In some implementations, the orchestrator 250 may control the accessibility to each tag by the host systems 220A-D. The orchestrator 250 may make global control and management decisions about a cluster of the host systems 220A-D. The orchestrator 250 may be responsible for maintaining the desired state (i.e., a state desired by a client when running the cluster) of the host systems 220A-D, such as which applications are running and which container images they use, which resources should be made available for them, and other configuration details. In some implementations, the orchestrator 250 may be a container orchestration system, such as Kubernetes. In some implementations, the orchestrator 250 may be used to provide a containerized computing services platform, such as a Platform-as-a-Service (PaaS) system. The PaaS system provides resources and services (e.g., micro-services) for the development and execution of applications owned or managed by multiple users. A PaaS system provides a platform and environment that allow users to build applications and services in a clustered compute environment (the “cloud”). The orchestrator 250 may include nodes to execute applications and/or processes associated with the applications. A “node” providing computing functionality may provide the execution environment for an application. In some implementations, the “node” may include a virtual machine that is hosted on a physical machine, such as the host system 220A-220D implemented as part of the clouds. In some implementations, nodes may additionally or alternatively include a group of virtual machines, a container, or a group of containers to execute functionality of the PaaS applications. When nodes are implemented as virtual machines, they may be executed by operating systems (OSs) on each host system 220A-220D. Although implementations of the disclosure are described in accordance with a certain type of system, this should not be considered as limiting the scope or usefulness of the features of the disclosure. For example, the features and techniques described herein can be used with other types of multi-tenant systems and/or containerized computing services platforms.

The host systems 220A-D, (e.g., through a node running on the host systems 220A-D), may request allocation of tagged capacity in DCDs 230A-230D. For example, a host system 220A-D, through a node (e.g., an application, a virtual machine) running on the host systems 220A-D, may request of allocation tagged capacity in DCDs 230A-230D, where the request may specify a capacity size.

For initial allocation of tagged capacity, the controller 215 and/or the fabric manager 240 may determine the portions of the DCDs 230A-230D for allocation. In some implementations, the controller 215 may determine an available portion, in the requested capacity size, of the DCDs 230A-230D to be allocated to the host system 220A and request the fabric manager 240 to provide a tag. The controller 215 may receive the tag from the fabric manager 240 and assign the tag to the allocated portion referred to as the tagged capacity unit, for example, the tagged capacity unit 231A or 232A. In some implementations, the fabric manager 240 may determine an available portion, in the requested capacity size, of the DCDs 230A-230D to be allocated to the host system 220A and assign a tag to the allocated portion referred to as the tagged capacity unit, for example, the tagged capacity unit 231A or 232A. In various implementations, the tag is created by the fabric manager 240 so that the tag is globally unique. The controller 215 may store, in the tag mapping data structure 217, the tag, the DPA ranges of the allocated portions of the DCDs 230A-230D, and the host identifier (or a host group identifier) that defines the host system(s) that can access the tag.

Upon the initial allocation of the tagged capacity unit, the host system 220A-220D may write data to the tagged capacity unit. Using the host system 220A and the DCD 230A as an example, upon the initial allocation of the tagged capacity unit 231A or 232A to the host system 220A, the controller 215 may receive, from host system 220A, data created by an application running on the host system 220A. The data can include content that is reflective of a state of the application (e.g., the data can include information that represents the values of the variables, the memory layout, the position of the instruction pointer, and other details about the state of the application). The controller 215 may store the data in the tagged capacity unit 231A or 232A. The controller 215 can write the data to the tagged capacity unit 231A or 232A and map the one or more DPA ranges identifying respective locations containing the data on the CXL memory device 210 with corresponding virtual address ranges in the virtual address space available to the host system 220A (i.e., the virtual/logical address space allocated by a host system to the host application that created the data). As such, the controller 215 can record the data at respective locations identified by a set of corresponding address ranges (e.g., contiguous physical address range or extent list of non-contiguous physical address ranges indicating the locations on the CXL memory device 210 of the data). An example of using the tagged capacity unit 231A or 232A as a source tag for a migrate-out command and a migrate-in command will be illustrated below with respect to FIG. 2A.

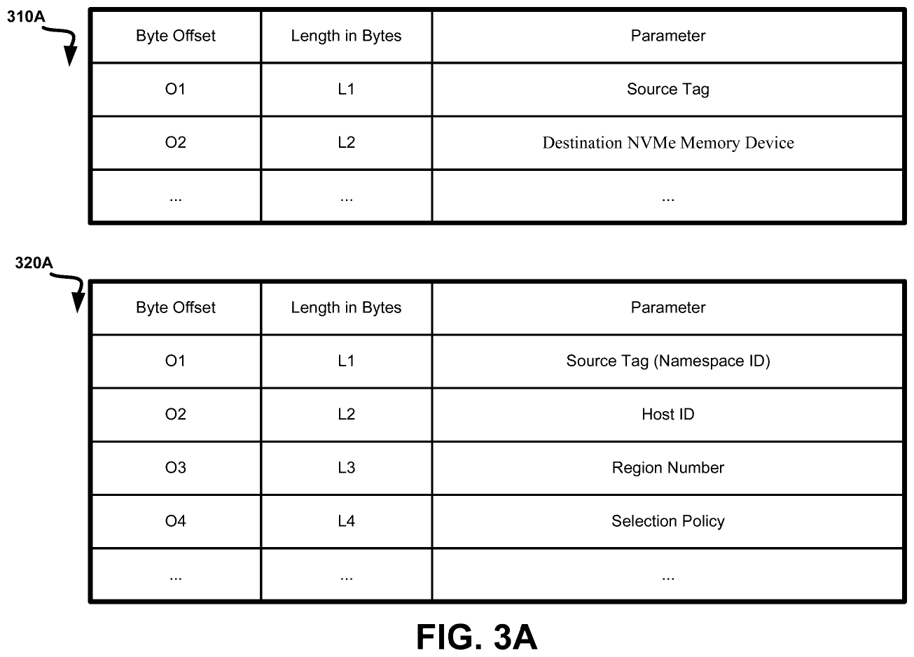

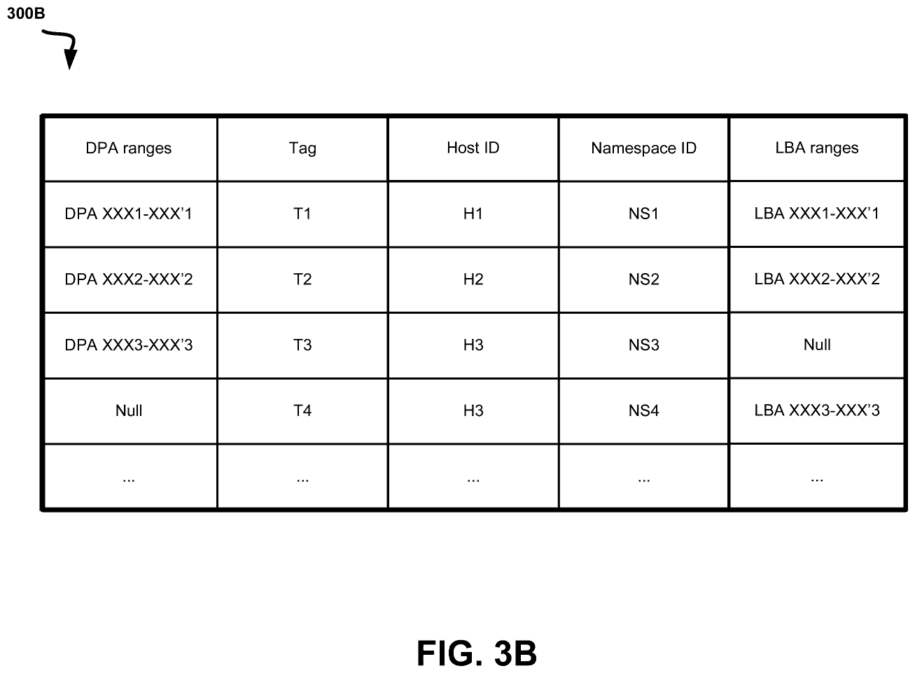

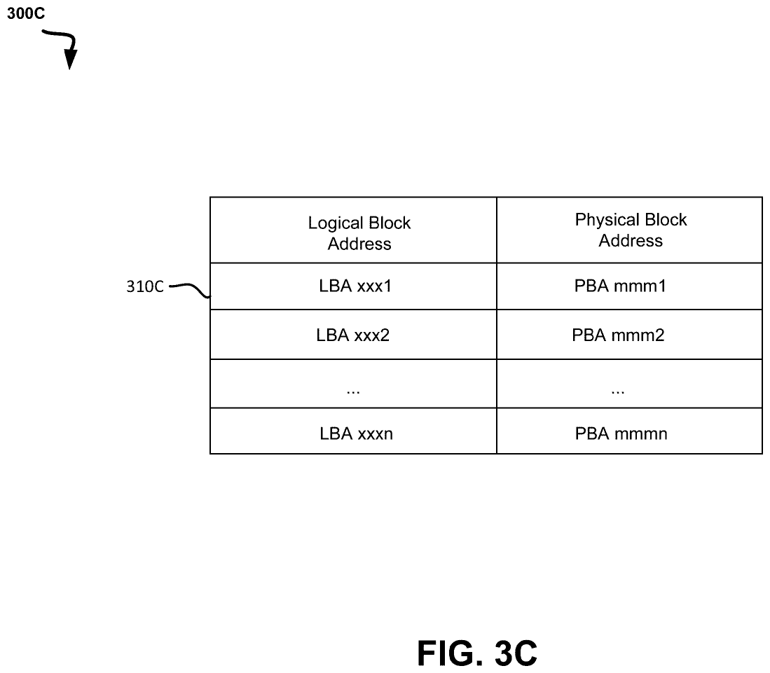

FIG. 3A illustrates an example of a migrate-out command 310A and an example of a migrate-in command 320A. The migrate-out command 310A may include bytes designated to represent parameters including a source tag, a destination NVMe memory device, etc. Each parameter of the migrate-out command may have specific length in bytes and be placed at a specific byte offset. The source tag of the migrate-out command may identify a tag, where the data associated with the tag is to be migrated out. The destination NVMe memory device of the migrate-out command may identify a NVMe memory device where the data associated with the source tag is to be migrated.

The migrate-in command 320A may include bytes designated to represent parameters including a source tag (a namespace ID), a host identifier (or a host group identifier), a region number, a selection policy, etc. In some implementations, the migrate-in command may further include a destination tag (not shown). Each parameter of the migrate-in command may have specific length in bytes and be placed at a specific byte offset. The source tag of the migrate-in command may identify a source tag that corresponds to a namespace, where the data stored in the NVMe memory device and that was previously associated with the source tag and is to be migrated in a tagged capacity unit associated with a destination tag. The host identifier (or a host group identifier) of the migrate-in command may identify the host system(s) to which the destination tag of the migrate-in command is to be assigned. The region number of the migrate-in command may identify the region of the DCDs in which the tagged capacity unit associated with a destination tag is, where the identified region has various attributes, including whether the region is writable and/or readable, whether the region has the hardware managed coherency that the most recent copy from a cache line is coherent in the hardware, or whether the region is sharable by one or more host systems. The selection policy of the migrate-in command may specify the policy for selecting the taggable DC unit of the DCDs as the tagged capacity unit associated with a destination tag. For example, a “free and contiguous” policy may allow a memory controller (e.g., controller 215) to select a free and contiguous space in the DCDs, while a “prescriptive” policy may allow a fabric manager (e.g., the fabric manager 240) to select a prescriptive space in the DCDs, The migrate-in command may optionally include bytes designated to represent parameters including the capacity size of the taggable DC unit associated with the destination tag, the number of the taggable DC unit associated with the designation tag, etc. Although not shown FIG. 3A, the migrate-in command may include bytes designated to represent parameters including whether a new tag is to be assigned as the destination tag (or the source tag is reused).

FIG. 3B illustrates an example tag/namespace mapping data structure 300B (such as the tag/namespace mapping data structure 217) that can be used to implement the migrate-out command and the migrate-in command. The tag mapping data structure 300B may include an item “DPA ranges,” an item “tag,” and an item “host ID.” The item “DPA ranges” indicates the locations (i.e., one or more physical address ranges of the tagged capacity unit) storing the data on the CXL memory device. The physical address ranges identifying respective locations on the CXL memory device storing the data can be referred to as “the physical address ranges of the tagged capacity unit” containing data. The item “tag” indicates the tag associated with the tagged capacity unit. The item “host ID” indicates the host system from which the tagged capacity unit associated with the tag can be accessed. The tag/namespace mapping data structure 300B may include multiple records, and each record may correspond to a tag, and each record includes multiple items described here.

The tag/namespace mapping data structure 300B may further include an item “namespace ID” and an item “LBA ranges.” The item “namespace ID” indicates the NVMe namespace where the tag has been migrated out. The item “LBA ranges” indicates the logical addresses represented by the namespace ID. For example, namespace ID NS1 can include an LBA range from xxx1 to xxx′1, namespace ID NS2 can include an LBA range from xxx2 to xxx′2, etc.

In view of the item “DPA ranges,” an item “tag,” an item “host ID,” the tag/namespace mapping data structure 300B can be used to map the DPA ranges to the host system by mapping the physical address ranges of the tag to corresponding virtual address ranges in a virtual address space of the host system (i.e., the virtual/logical address space allocated by a host system to a host application that is permitted to access the data).

In view of the item “tag” and the item “namespace ID,” the tag/namespace mapping data structure 300B can be used to map the tag to the namespace ID such that a host system can map the tag of the CXL memory device to corresponding namespace in the NVMe memory device.

FIG. 3C illustrates an example L2P table 300C associated with a namespace in a NVMe memory device, in accordance with some embodiments of the present disclosure. L2P table 300C can include one or more entries 310C. Each entry 310C can include a logical block address (LBA) field that is configured to store an address (or an identifier) associated with an LBA. Each entry 310C can also include a physical block address (PBA) field that is configured to store an address (or an identifier) associated with a PBA (e.g., residing at a NVMe memory device 270A, 270B). In some embodiments, the controller 215 can generate, for each namespace, a mapping between an address or identifier associated with a particular LBA and an address or identifier associated with a particular PBA, for example, during an initialization of the NVMe memory device 270A, 270B. The controller 215 can store the generated mapping at the NVMe memory device 270A, 270B.

Now referring to FIG. 2A, the implementation of the migrate-out command and the implementation of the migrate-in command each is illustrated as an example using the host systems 220A and 220B and the DCDs 230A and 230B. It is noted that each of the migrate-out command and the migrate-in command can be implemented by one or more host systems, one or more nodes, and one or more DCDs. For example, the host system associated with a source tag may or may not be the same as the host system that issues the migrate-out command; the host system associated with a namespace ID (or source tag) may or may not be the same as the host system that issues the migrate-in command. In some implementations, the command component 113A included in the fabric manager 240 and the command component 113B included in the controller 215 may perform the functions of the migrate-out & migrate-in command component 113 of FIG. 1, and operate together to implement the migrate-out command and/or migrate-in command.

To implement the migrate-out command, the host system 220B may send, through the node (e.g., an application, a virtual machine) running on the host system 220B, a migrate-out command to the CXL memory device 210. The migrate-out command may enable the host system 220B to move the data stored in a tagged capacity unit with a source tag to a physical unit associated with a namespace ID. The migrate-out command may make the source tag hidden from the host system 220B. The migrate-out command may further enable the host system 220B to free the tagged capacity unit (e.g., the DPA ranges) associated with the source tag. Freeing the tagged capacity unit involves disassociating the DPA ranges with the source tag and mark the DPA ranges as free to use. In some implementations, the migrate-out command may make one of the tag and the mapped namespace to be visible to a host system, and the other invisible to the host system.

For example, the host system 220B may send a migrate-out command, where the migrate-out command includes a first source tag 231A and a destination NVMe memory device 270A. For example, the first source tag 231A may be associated with the host system 220A. The command component 113B may assign the namespace 271A as a set of LBAs of the NVMe memory device 270A, find a free memory space (e.g., PBA ranges) that fits the size of the data of the source tag 231A, and store the data of the source tag 231A in the memory space associated with the namespace 271A. In some implementations, the command component 113B may assign the namespace 271A using the value same as the value of the source tag. Upon storing the data of the source tag, the command component 113B may update the L2P table 281A associated with the namespace 271A. In some implementations, responsive to determining that the migrate-out command instructs to not free the memory space, i.e., keep the data of the first source tag 231A as it is in the DCD 230A, the command component 113B may make the first source tag 231A inaccessible without additional actions. The command component 113B may update the tag/namespace mapping data structure 217 by modifying the record of the first source tag 231A. The command component 113B may notify the host system 220B regarding the completion of the migrate-out command. Upon the completion of the migrate-out command, the command component 113B may make the source tag 231A invisible to the host system 220B.

As another example, the host system 220B may send a migrate-out command, where the migrate-out command includes a second source tag 232A and a destination NVMe memory device 270A. The command component 113B may assign the namespace 272A as a set of LBAs of the NVMe memory device 270A, find a free memory space (e.g., PBA ranges) that fits the size of the data of the source tag 232A, and store the data of the source tag 232A in the memory space associated with the namespace 272A. In some implementations, the command component 113B may assign the namespace 272A using the value same as the value of the source tag. Upon storing the data of the source tag, the command component 113B may update the L2P table 283A associated with the namespace 272A. In some implementations, responsive to determining that the migrate-out command instructs to free the memory space of the source tag, the command component 113B may free the tagged capacity unit associated with the second source tag 232A. The command component 113B may update the tag/namespace mapping data structure 217 by modifying the record of the second source tag 232A. The command component 113B may notify the host system 220B regarding the completion of the migrate-out command. Upon the completion of the migrate-out command, the command component 113B may make the source tag 231A invisible to the host system 220B.

To implement the migrate-in command, the host system 220C may send, through the node (e.g., an application, a virtual machine) running on the host system 220C, a migrate-in command to the CXL memory device 210. The migrate-in command may enable the host system 220C to move data associated with a namespace (mapped with a source tag) to a tagged capacity unit associated with a destination tag so that the data is put back in CXL memory device and a full access of the data can be given to the host system 220C. The migrate-in command may make the namespace hidden from the host system 220C. The migrate-out command may further enable the host system 220B to free the physical storage unit (e.g., the PBA ranges) associated with the namespace. Freeing the physical storage unit involves disassociating the PBA ranges with the source tag and mark the PBA ranges as free to use. In some implementations, the migrate-in command may make one of the tag and the mapped namespace to be visible to a host system, and the other invisible to the host system.

For example, the host system 220C may send a migrate-in command, where the migrate-in command includes a source tag 231A, a host identifier (or a host group identifier) 220C, and a selection policy as “free and contiguous.” The command component 113B may use the source tag 231A to determine the namespace 271A mapped to the source tag 231A, by using the tag/namespace mapping data structure 217. Responsive to determining that the selection policy is “free and contiguous,” the command component 113B may determine a taggable DC unit in the region 233A (e.g., same region as the source tag), and send a request for a tag to the command component 113A. In response to the tag request, the command component 113A may send the tag to the command component 113B. The command component 113B may assign the tag to the determined taggable DC unit as the tagged capacity unit 233A. The command component 113B may use the L2P table of the namespace 271A to identify the location of the NVMe memory device 270A, retrieve the data stored in the location, and store the data in tagged capacity unit 233A. Upon storing the data back to the tagged capacity unit, the command component 113B may update the L2P table 281A associated with the namespace 271A. In some implementations, responsive to determining that the migrate-in command instructs to not free the memory space, i.e., keep the data of the namespace 271A as it is in the NVMe memory device 270A, the command component 113B may make the namespace 271A inaccessible without additional actions. The command component 113B may update the tag/namespace mapping data structure 217 by modifying the record of the tag associated with tagged capacity unit 233A. The command component 113B may notify the host system 220C regarding the completion of the migrate-in command. Upon the completion of the migrate-in command, the command component 113B may make the namespace 271A invisible to the host system 220B.

As another example, the host system 220C may send a migrate-in command, where the migrate-in command includes a source tag 232A, a host identifier (or a host group identifier) 220C, a region number 236B, and a selection policy as “prescriptive”. The command component 113B may use the source tag 232A to determine the namespace 271A mapped to the source tag 231A, by using the tag/namespace mapping data structure 217. Responsive to determining that the selection policy is “prescriptive,” the command component 113A may determine a taggable DC unit in the region 236B, and send a tag with information of the determined taggable DC unit to the command component 113B. The command component 113B may assign the tag to the determined taggable DC unit as the tagged capacity unit 231B. The command component 113B may use the L2P table of the namespace 271A to identify the location of the NVMe memory device 270A, retrieve the data stored in the location, and store the data in tagged capacity unit 231B. Upon storing the data back to the tagged capacity unit, the command component 113B may update the L2P table 281A associated with the namespace 271A. In some implementations, responsive to determining that the migrate-in command instructs to free the memory space of the namespace, the command component 113B may free the physical storage unit associated with the namespace 271A. The command component 113B may update the tag/namespace mapping data structure 217 by modifying the record of the tag associated with tagged capacity unit 231B. The command component 113B may notify the host system 220C regarding the completion of the migrate-in command. Upon the completion of the migrate-in command, the command component 113B may make the namespace 271A invisible to the host system 220B.

FIG. 2B is a schematic block diagram of a system 200B implementing taggable dynamic capacity units in a compute express link (CXL) memory device. In various embodiments, the system 200B includes one or more host systems 220A-D (such as the host system 120), a CXL memory device 210 (such as the CXL memory device 110) that includes a controller 215 (e.g., controller 115) and DCDs 230A-230D, a NVMe sub-system 290 that includes a controller 295 and NVMe memory devices 270A-270B, a CXL fabric 245, a fabric manager 240, and an orchestration cluster 250.

The system 200B differs from the system 200A in that the controllers for CXL memory device and the NVMe memory device are separate. As such, the NVMe memory devices 270A-270B may form a separate NVMe sub-system 290 that includes the controller 295. The controller 295 may perform the function of the controller 215 as described above with respect to FIG. 2A when the controller 215 performs the operations of the NVMe memory devices 270A-270B. The controller 295 may include a tag/namespace mapping data structure 297 that is same as the tag/namespace mapping data structure 217 to facilitate the operations described herein. In some embodiments, aspects (to include hardware and/or firmware functionality) of the controller 295 are included in the processing logic of NVMe memory devices 270A-270B.

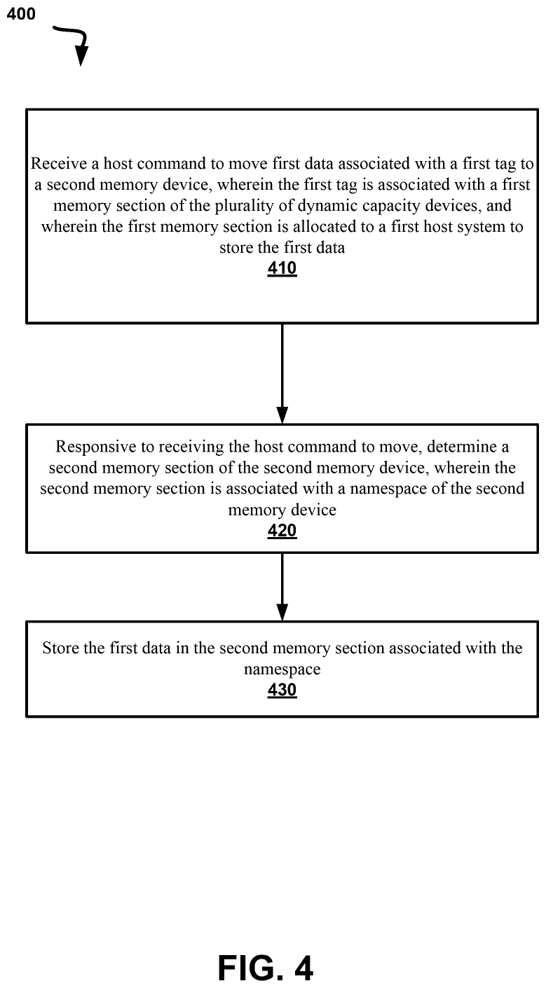

FIG. 4 is a flow diagram of an example method 400 for using a migrate-out command associated with tagged capacity in a compute express link (CXL) memory device coupled with a nonvolatile memory express (NVMe) memory device, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the migrate-out & migrate-in command component 113 of FIG. 1 or the controller 215 (including the command component 113B) and the fabric manager 240 (including the command component 113A) of FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic can receive a host command (migrate-out command) to move first data associated with a first tag to a second memory device (e.g., NVMe memory device 270A-270B), wherein the first tag is associated with a first memory section (e.g., memory section corresponding to 231A or 232A) of a plurality of dynamic capacity devices (e.g., DCD 230A-230D) of a first memory device (e.g., the CXL memory device 210), and wherein the first memory section is allocated to a first host system to store the first data. In some implementations, each of the plurality of dynamic capacity devices comprises a plurality of memory sections, wherein each of the plurality of memory sections is associated with a respective one of a plurality of tags, and wherein each of the plurality of tags is unique. In some implementations, the host command to move specifies the first tag and whether to free the first memory section.

In some implementations, the first memory device comprises a compute express link (CXL) enabled memory device. In some implementations, the second memory device comprises a nonvolatile memory express (NVMe) memory device. In some implementations, the second memory device is included in the first memory device that includes the plurality of dynamic capacity devices. In some implementations, the second memory device is not included in the first memory device that includes the plurality of dynamic capacity devices.

In some implementations, the processing logic can receive an allocation request from the first host system, where the allocation request specifies a first host system and a capacity, allocate the first memory section to the first host system, and associate the first tag with the first memory section. In some implementations, the processing logic can receive the first data from the host system and store the first data in the first memory section. In some implementations, the processing logic can create the first tag responsive to receiving an allocation request by a node in an orchestrator cluster, wherein the node runs on the first host system.

In some implementations, the processing logic can receive an allocation request from the first host system, where the allocation request specifies a first host system and a capacity, allocate the second memory section to the first host system, and associate the second tag with the second memory section. In some implementations, the processing logic can create the second tag responsive to receiving an allocation request by a node in an orchestrator cluster, wherein the node runs on the first host system.

In some implementations, the processing logic can map the first tag to the first memory section and the first host system. In some implementations, the first tag is shared by the first host system and another host system. In some implementations, the capacity of the first memory section allocated to the first host system and associated with the first tag is immutable.

At operation 420, responsive to receiving the host command to move, the processing logic can determine a second memory section of the second memory device, wherein the second memory section is associated with a namespace of the second memory device.

In some implementations, the processing logic can determine whether the host command indicates to free the first memory section. In some implementations, the host command indicates to free the first memory section by using a flag bit included in the host command.

At operation 430, the processing logic can store the first data in the second memory section associated with the namespace. In some implementations, the processing logic can store the first data in the second memory device and store, in the metadata of the first data, the first tag with the first data in the second memory device. In some implementations, responsive to storing the first data, the processing logic can make the first tag, in an item of a mapping data structure, invisible to the first host system.

In some implementations, the processing logic can determine the second memory device by sending a request, to the second memory device, for a free memory space with a specific size, where the specific size includes the size of the first data, and upon receiving an indication, from the second memory device, that a free memory space with the specific size is available. In some implementations, the processing logic can determine the second memory device by broadcasting a request, to a set of memory devices, for a free memory space with a specific size, where the specific size includes the size of the first data, and upon receiving an indication, from the second memory device, that a free memory space with the specific size is available.

In some implementations, responsive to determining that the host command indicates to free the first memory section, the processing logic can free the first memory section. The processing logic can disassociate the memory addresses (e.g., DPA ranges) of the first memory section with the first tag. The processing logic can disassociate the memory addresses (e.g., DPA ranges) of the first memory section, in a mapping data structure, with the first tag.

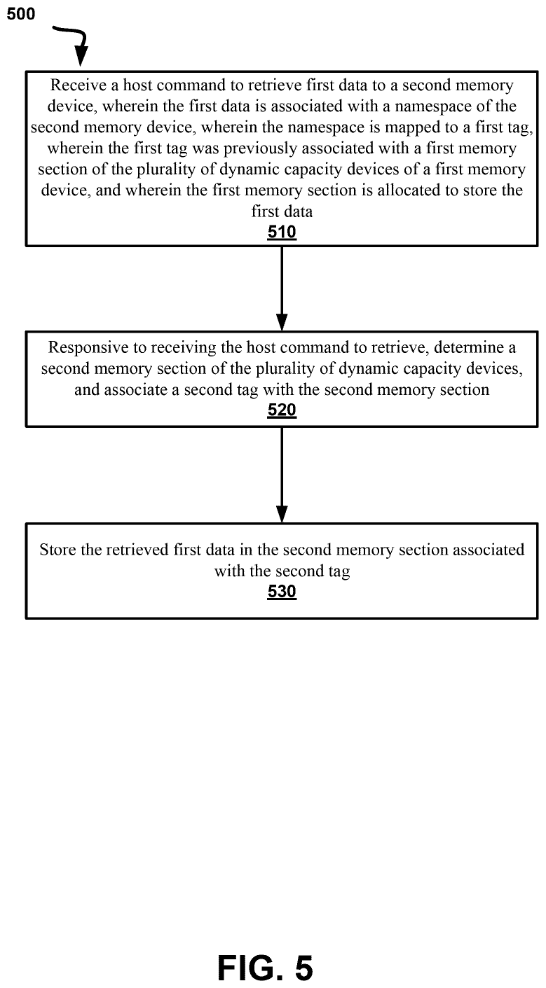

FIG. 5 is a flow diagram of an example method 500 for using a migrate-in command associated with tagged capacity in a compute express link (CXL) memory device coupled with a nonvolatile memory express (NVMe) memory device, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the migrate-out & migrate-in command component 113 of FIG. 1 or the controller 215 (including the command component 113B) and the fabric manager 240 (including the command component 113A) of FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, the processing logic can receive a host command (migrate-in command) to retrieve first data from a second memory device (e.g., NVMe memory device 270A-270B), wherein the first data is associated with a namespace of the second memory device, wherein the namespace is mapped to a first tag, wherein the first tag was previously associated with a first memory section (e.g., memory section corresponding to 231A or 232A) of a plurality of dynamic capacity devices (e.g., DCD 230A-230D) of a first memory device (e.g., the CXL memory device 210), and wherein the first memory section is allocated to store the first data. In some implementations, each of the plurality of dynamic capacity devices comprises a plurality of memory sections, wherein each of the plurality of memory sections is associated with a respective one of a plurality of tags, and wherein each of the plurality of tags is unique.

In some implementations, the first memory device comprises a compute express link (CXL) enabled memory device. In some implementations, the second memory device comprises a nonvolatile memory express (NVMe) memory device. In some implementations, the second memory device is included in the first memory device that includes the plurality of dynamic capacity devices. In some implementations, the second memory device is not included in the first memory device that includes the plurality of dynamic capacity devices.

In some implementations, the host command to retrieve specifies the first tag. In some implementations, the processing logic can determine the namespace, via a mapping data structure, corresponding to the first tag. In some implementations, the host command to retrieve specifies an identifier of the host system. In some implementations, the host command to retrieve specifies at least one of: a region identifier of the memory device, or a selection policy for selecting a memory section.

At operation 520, responsive to receiving the host command to retrieve, the processing logic can determine a second memory section (e.g., memory section corresponding to 233A or 231B) of the plurality of dynamic capacity devices, and associate a second tag with the second memory section. In some implementations, the processing logic can make the namespace, in an item of a mapping data structure, invisible to the first host system.

In some implementations, the host command to retrieve is received from a second host system, and wherein the host command specifies the second host system, and the processing logic can make the namespace, in an item of a mapping data structure, invisible to the second host system. In some implementations, the processing logic can map the second tag to the second memory section and the second host system. In some implementations, the second tag is shared by the second host system and another host system. In some implementations, the capacity of the second memory section allocated to the second host system and associated with the second tag is immutable.

At operation 530, the processing logic can retrieve the first data and store the retrieved first data in the second memory section associated with the second tag. In some implementations, the processing logic can use the logical address (e.g., LBA ranges) in the L2P table of the namespace to find the data stored in the second memory device (e.g., NVMe memory device 270A-270B) and then retrieve the data and store it in the second memory section (e.g., memory section corresponding to 233A or 231B).

In some implementations, the processing logic can determine whether the host command indicates to free the physical storage unit associated with the namespace in the second memory device (e.g., NVMe memory device 270A-270B). In some implementations, the host command indicates to free the physical storage unit by using a flag bit included in the host command. In some implementations, responsive to determining that the host command indicates to free the physical storage unit associated with the namespace in the second memory device (e.g., NVMe memory device 270A-270B), the processing logic can free the physical storage unit. The processing logic can disassociate the memory addresses (e.g., PBA ranges) of the physical storage unit with the namespace.

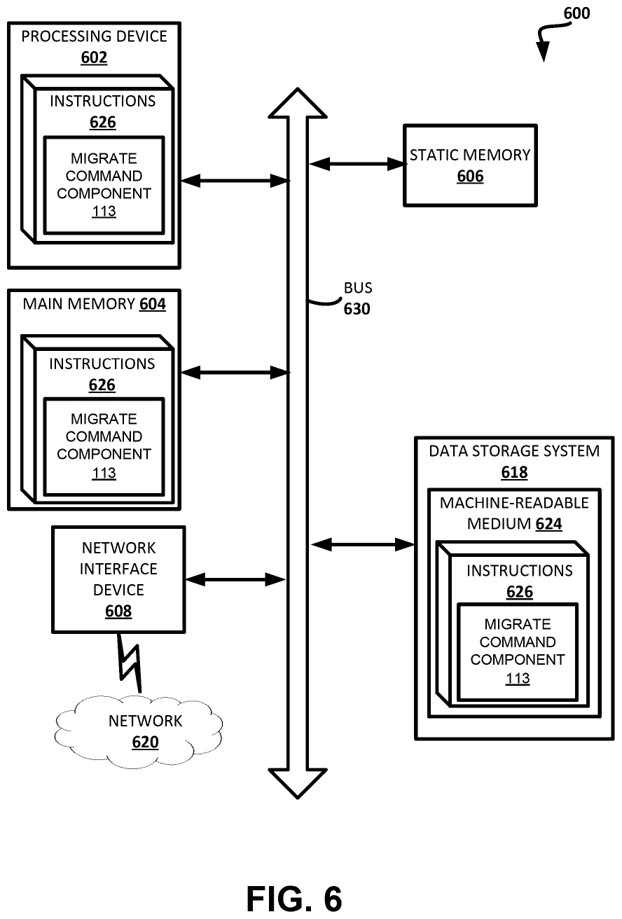

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the CXL memory device 110 of FIG. 1) or can be used to perform the operations of a controller (e.g., to execute an operating system to perform operations corresponding to the migrate command component 113 of FIG. 1 or the controller 215 (including the command component 113B) and the fabric manager 240 (including the command component 113A) of FIG. 2). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the CXL memory device 110 of FIG. 1.

In one embodiment, the instructions 626 include instructions to implement functionality corresponding to an APL management component (e.g., the migrate command component 113 of FIG. 1 or the controller 215 (including the command component 113B) and the fabric manager 240 (including the command component 113A) of FIG. 2). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a first memory device comprising a plurality of dynamic capacity devices;
a second memory device; and
a processing device, operatively coupled with the first memory device and the second memory device, to perform operations comprising:
receiving a host command to move first data associated with a first tag to the second memory device, wherein the first tag is associated with a first memory section of the plurality of dynamic capacity devices, and wherein the first memory section is allocated to a first host system to store the first data;
responsive to receiving the host command to move, determining a second memory section of the second memory device, wherein the second memory section is associated with a namespace of the second memory device; and
storing the first data in the second memory section associated with the namespace.

2. The system of claim 1, wherein each of the plurality of dynamic capacity devices comprises a plurality of memory sections, wherein each of the plurality of memory sections is associated with a respective one of a plurality of tags, and wherein each of the plurality of tags is unique.

3. The system of claim 1, wherein the host command specifies the first tag.

4. The system of claim 1, wherein the host command specifies the second memory device.

5. The system of claim 1, wherein the operations further comprise:
responsive to determining that the host command indicates to free the first memory section, disassociating the first tag with the first memory section.

6. The system of claim 1, wherein a capacity of the first memory section allocated to the first host system and associated with the first flag is immutable.

7. The system of claim 1, wherein the first memory device comprises a compute express link (CXL) enabled memory device.

8. The system of claim 1, wherein the second memory device comprises a nonvolatile memory express (NVMe) memory device.

9. The system of claim 1, wherein the operations further comprise:
responsive to receiving a first allocation request from the first host system, determining the first memory section and associating the first tag with the first memory section; and
storing the first data in the first memory section.

10. The system of claim 9, wherein the operations further comprise:
creating the first tag responsive to receiving the first allocation request by a first node in an orchestrator cluster, wherein the first node runs on the first host system.

11. The system of claim 1, wherein the operations further comprise:
responsive to storing the first data, making the first tag, in an item of a mapping data structure, invisible to the first host system.

12. A method comprising:
receiving, by a processing device, a host command to move first data associated with a first tag to a second memory device, wherein the first tag is associated with a first memory section of a plurality of dynamic capacity devices of a first memory device, and wherein the first memory section is allocated to a first host system to store the first data;
responsive to receiving the host command to move, determining a second memory section of the second memory device, wherein the second memory section is associated with a namespace of the second memory device; and
storing the first data in the second memory section associated with the namespace.

13. The method of claim 12, wherein each of the plurality of dynamic capacity devices comprises a plurality of memory sections, wherein each of the plurality of memory sections is associated with a respective one of a plurality of tags, and wherein each of the plurality of tags is unique.

14. The method of claim 12, wherein the host command specifies the first tag.

15. The method of claim 12, wherein the host command specifies the second memory device.

16. The method of claim 12, further comprising:
responsive to determining that the host command indicates to free the first memory section, disassociating the first tag with the first memory section.

17. The method of claim 12, wherein a capacity of the first memory section allocated to the first host system and associated with the first flag is immutable.

18. The method of claim 12, wherein the first memory device comprises a compute express link (CXL) enabled memory device, and wherein the second memory device comprises a nonvolatile memory express (NVMe) memory device.

19. The method of claim 12, further comprising:
responsive to storing the first data, making the first tag, in an item of a mapping data structure, invisible to the first host system.

20. A non-transitory computer-readable storage medium comprising instructions that, when executed by a processing device, cause the processing device to perform operations comprising:
receiving a host command to move first data associated with a first tag to a second memory device, wherein the first tag is associated with a first memory section of a plurality of dynamic capacity devices of a first memory device, and wherein the first memory section is allocated to a first host system to store the first data;
responsive to receiving the host command to move, determining a second memory section of the second memory device, wherein the second memory section is associated with a namespace of the second memory device; and
storing the first data in the second memory section associated with the namespace.
